(19) United States
(12) Patent Application Publication
(10) Pub. No.: US 2019/0249711 A1
(43) Pub. Date: Aug. 15, 2019

(54) MAIN BEARING FOR CRANKSHAFT OF INTERNAL COMBUSTION ENGINE

(71) Applicant: DAIDO METAL COMPANY LTD., Nagoya (JP)

(72) Inventors: Seiji AMANO, Inuyama (JP); Toru WATANABE, Inuyama (JP)

(21) Appl. No.: 16/256,035

(22) Filed: Jan. 24, 2019

(30) Foreign Application Priority Data
Feb. 9, 2018 (JP) 2018-021568

(51) Int. Cl. F16C 9/02; F16C 33/10

(52) U.S. Cl. CPC F16C 9/02; F16C 33/1065

(57) ABSTRACT

A main bearing for a journal portion of a crankshaft includes a pair of upper and lower half bearings combined with each other to form a cylindrical shape. Only the upper half bearing includes an oil groove formed on its inner peripheral surface to extend in a circumferential direction, an oil hole piercing from the oil groove to an outer peripheral surface of the upper half bearing, and a plurality of axial grooves formed on its inner peripheral surface to extend in an axial direction so as to intersect with the oil groove. A groove depth D2 of the axial groove is not more than 10% of a groove depth D1 of the oil groove, and an axial length L2 of the axial groove is not less than 70% of an axial length L1 of the upper half bearing.

### BACKGROUND OF THE INVENTION

### (1) Field of the Invention

The present invention relates to a main bearing, and particularly to a main bearing for a crankshaft of an internal combustion engine that bears a journal portion of the crankshaft, and is configured so that lubricating oil supplied to an inner peripheral surface of the main bearing is supplied, through an internal lubricating oil path in the crankshaft, to an inner peripheral surface of a connecting rod bearing that bears a crankpin.

### (2) Description of Related Art

A crankshaft of an internal combustion engine is, at a journal portion thereof, borne by a cylinder block bottom part of the internal combustion engine via a main bearing composed of a pair of half bearings. For the main bearing, lubricating oil discharged by an oil pump is fed into a lubricating oil groove formed along an inner peripheral surface of the main bearing, from an oil gallery formed in a cylinder block wall through a through-hole (oil hole) formed in a wall of the main bearing. Moreover, a first lubricating oil path is formed to pierce through the journal portion in its radial direction, and openings formed at both ends of the first lubricating oil path communicate with the lubricating oil groove of the main bearing. Further, a second lubricating oil path passing through a crank arm portion is formed so as to branch from the first lubricating oil path of the journal portion, and the second lubricating oil path communicates with a third lubricating oil path formed to pierce through the crankpin in its radial direction. In this way, the lubricating oil fed into the lubricating oil groove formed on the inner peripheral surface of the main bearing from the oil gallery in the cylinder block wall through the through-hole is supplied between the crankpin and a slide surface of a connecting rod bearing consisting of a pair of half bearings, from a discharge opening which is open at the end of the third lubricating oil path, through the first lubricating oil path, the second lubricating oil path, and the third lubricating oil path (see JP-A-H8-277831, for example). The lubricating oil is supplied between the crankshaft, and the main bearing and the connecting rod bearing in this way.

In order to reduce a frictional loss between a half bearing and a crankshaft during sliding, it is proposed to form a plurality of small recesses and grooves on a slide surface of the half bearing (see JP-A-2000-504089 and JP-A-2002-155946, for example).

### BRIEF SUMMARY OF THE INVENTION

Foreign matters remaining in a lubricating oil path tend to mix with lubricating oil supplied into a lubricating oil groove formed along an inner peripheral surface of a main bearing which bears a journal portion of a crankshaft. Here, the foreign matters are metal scraps due to cutting of an oil path, casting sand due to casting and the like, and these foreign matters follow the flow of lubricating oil by the rotation of the crankshaft. In recent years, internal combustion engines require higher-speed rotation of a crankshaft in order to increase output. Therefore, these foreign matters which are greater in specific gravity than the lubricating oil move along a groove bottom under a centrifugal action while moving in a lubricating oil groove formed along an inner peripheral surface of a main bearing. This means that the number of foreign matters in the lubricating oil flowing in an upper region (not a lower region close to the groove bottom, but a region on a side close to the crankshaft) of the lubricating oil groove is small. On the other hand, weight reduction of the crankshaft is also required in order to improve fuel efficiency. Therefore, the crankshaft deforms or bends at its center due to pressure produced in oil between a slide surface of a main bearing and the surface of a journal portion. Accordingly, the crankshaft is in contact with the slide surface in the vicinity of an axial end of the main bearing, and therefore readily causes a frictional loss.

A conventional half bearing in which a plurality of small recesses are formed on a slide surface as lubricating oil pockets as described in JP-A-2000-504089 has the problem that, because a lubricating oil groove of a main bearing is not in communication with the small recesses, supply of oil to the vicinity of an axial end of the slide surface is not sufficient, and the slide surface in the vicinity of the axial end is in contact with the surface of a crankshaft after all, so that a frictional loss becomes large.

Further, in a conventional main bearing in which a plurality of shallow tilted grooves extending in an oblique direction from both axial sides of a lubricating oil groove formed along an inner peripheral surface toward end portions are formed as described in JP-A-2002-155946, when a crankshaft which rotates while constantly receiving a great variable load is apart from an inner peripheral surface of an upper half bearing, the flow of lubricating oil also follows the movement of the crankshaft, and further, foreign matters present in a lower region of the lubricating oil groove also move to an upper region of the lubricating oil groove. Accordingly, there is the problem that the foreign matters contained in the lubricating oil groove enter the tilted grooves together with lubricating oil, further enter a space between a slide surface of the main bearing and the surface of the crankshaft, and then contact the slide surface and the surface of the crankshaft, so that a frictional loss is caused.

Therefore, an object of the present invention is to provide a main bearing for a crankshaft of an internal combustion engine that increases supplying performance of lubricating oil to a slide surface during operation of the internal combustion engine, and prevents the above-described foreign matters contained in the lubricating oil in the lubricating oil groove from entering the slide surface.

According to the present invention, there is provided a main bearing for rotatably supporting a journal portion of a crankshaft of an internal combustion engine, wherein the journal portion includes a cylindrical body portion, a lubricating oil path extending through the cylindrical body portion, and at least one entrance opening of the lubricating oil path formed on an outer peripheral surface of the cylindrical body portion, and wherein

the main bearing includes a pair of upper and lower half bearings which are combined with each other to form a cylindrical shape,

only the upper half bearing of the pair of half bearings includes an oil groove formed on its inner peripheral surface to extend in a circumferential direction, and at least one oil hole extending through the upper half bearing from the oil groove to an outer peripheral surface of the upper half bearing, and the upper half bearing further includes a plurality of axial grooves formed on its inner peripheral surface that extends in an axial direction so as to intersect with the oil groove, and

a groove depth D2 of the axial groove is not more than 10% of a groove depth D1 of the oil groove, and an axial length L2 of the axial groove is not less than 70% of an axial length L1 of the upper half bearing.

According to the present invention, the groove depth D2 of the axial groove measured from the inner peripheral surface (or a slide surface) of the upper half bearing in a radial direction may be 0.5 to 30 μm.

Further, a groove width W of the axial groove may correspond to a circumferential length of 0.1 to 20 mm.

Furthermore, a group of grooves consisting of at least three of the axial grooves may be formed within a predetermined circumferential area (a circumferential angle θ1) on the inner peripheral surface of the upper half bearing.

Alternatively, the plurality of axial grooves may be formed at even intervals over the entire circumference of the inner peripheral surface of the upper half bearing.

The plurality of axial grooves may open at both axial ends of the upper half bearing.

Alternatively, the plurality of axial grooves may not open at either axial end of the upper half bearing.

### BRIEF DESCRIPTION OF THE SEVERAL VIEWS OF THE DRAWING

FIG. 1 is a sectional view in which a crankshaft of an internal combustion engine is cut at a journal portion and a crankpin portion;

FIG. 2 is a view in which a main bearing and the journal portion according to a first embodiment of the present invention are seen from an axial direction;

FIG. 3 is a view in which an upper half bearing of the main bearing according to the first embodiment of the present invention is seen from the axial direction;

FIG. 4 is a plan view in which the half bearing shown in FIG. 3 is seen from a slide surface side;

FIG. 5 is a sectional view of the half bearing shown in FIG. 3 along the line A-A;

FIG. 6 is a partially enlarged sectional view for illustrating an effect of the main bearing according to the first embodiment of the present invention;

FIG. 7 is a partially enlarged sectional view for illustrating the effect of the main bearing according to the first embodiment of the present invention;

FIG. 8 is a view in which an upper half bearing of a main bearing according to a second embodiment of the present invention is seen from an axial direction;

FIG. 9 is a plan view in which the half bearing shown in FIG. 8 is seen from a slide surface side;

FIG. 10 is a view in which an upper half bearing of a main bearing according to a third embodiment of the present invention is seen from an axial direction; and

FIG. 11 is a plan view in which the half bearing shown in FIG. 10 is seen from a slide surface side.

### DETAILED DESCRIPTION OF THE INVENTION

Hereinafter, embodiments of the present invention will be described with reference to the drawings. It should be noted that an axial groove is drawn in an exaggerated manner in the drawings to make it easier to understand.

### Embodiment 1

### (Overall Configuration of Bearing Device)

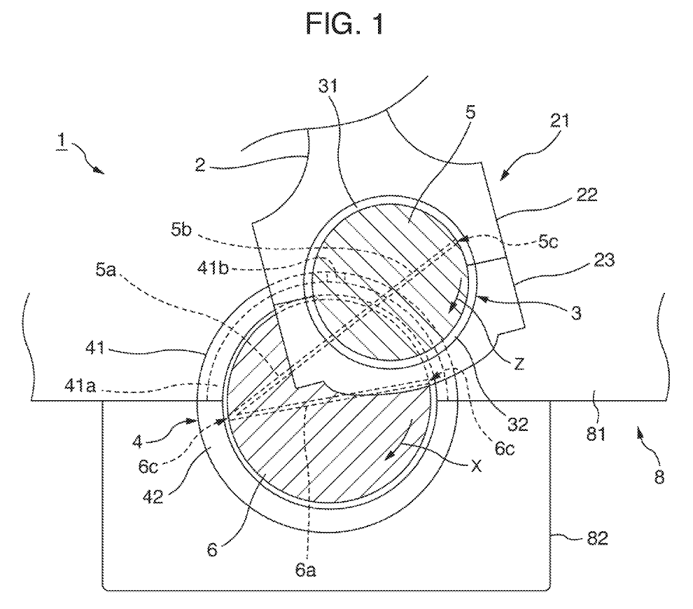

As shown in FIG. 1, a bearing device 1 according to the present embodiment includes a journal portion 6 supported by a bottom part of a cylinder block 8, a crankpin 5 which is formed integrally with the journal portion 6 to rotate around the journal portion 6, and a connecting rod 2 which transmits reciprocating movement to the crankpin 5 from an internal combustion engine. The bearing device 1 further includes a main bearing 4 which rotatably bears the journal portion 6, and a connecting rod bearing 3 which rotatably bears the crankpin 5, as slide bearings for bearing a crankshaft.

It should be noted that the crankshaft includes a plurality of journal portions 6 and a plurality of crankpins 5, however, one journal portion 6 and one crankpin 5 are shown in the drawings for convenience of explanation, and described accordingly. In FIG. 1, regarding a positional relationship in the depth direction of the drawing sheet, the journal portion 6 is located on a far side of the drawing sheet, and the crankpin 5 is located on a near side.

The journal portion 6 is supported by a cylinder block bottom part 81 of the internal combustion engine via the main bearing 4 composed of a pair of half bearings 41 and 42. An oil hole 41b piercing through a wall between an outer peripheral surface and an inner peripheral surface, and a lubricating oil groove 41a extending over the full length of the inner peripheral surface are formed in the half bearing 41 located on an upper side in FIG. 1. Further, the journal portion 6 has a lubricating oil path 6a piercing in a radial direction. If the journal portion 6 rotates in an arrow X direction, both end openings (entrance openings) 6c of the lubricating oil path 6a alternately communicate with the lubricating oil groove 41a of the main bearing 4.

The crankpin 5 is supported by a large end housing 21 (a rod side large end housing 22 and a cap side large end housing 23) of the connecting rod 2 via the connecting rod bearing 3 composed of a pair of half bearings 31 and 32.

As described above, lubricating oil discharged to the main bearing 4 by an oil pump is fed from an oil gallery formed in a cylinder block wall into the lubricating oil groove 41a formed along the inner peripheral surface of the upper half bearing 41, through the oil hole 41b formed in the wall of the upper half bearing 41 of the main bearing 4.

Furthermore, the first lubricating oil path 6a is formed to pierce in the radial direction of the journal portion 6, and the entrance openings 6c of the first lubricating oil path 6a communicate with the lubricating oil groove 41a. Still further, a second lubricating oil path 5a passing through a crank arm portion (not shown) is formed so as to branch from the first lubricating oil path 6a of the journal portion 6, and the second lubricating oil path 5a communicates with a third lubricating oil path 5b formed to pierce in a radial direction of the crankpin 5.

In this way, the lubricating oil is supplied into a clearance formed between the crankpin 5 and the connecting rod bearing 3 from the discharge opening 5c at the end of the third lubricating oil path 5b through the first lubricating oil path 6a, the second lubricating oil path 5a, and the third lubricating oil path 5b.

### (Configuration of Main Bearing)

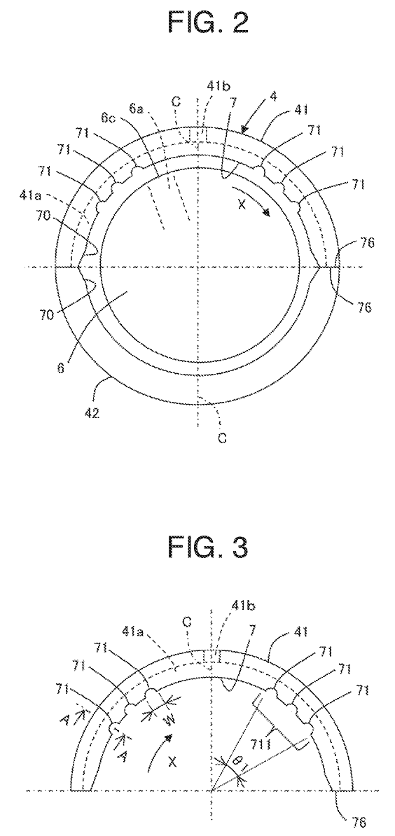

The main bearing 4 according to the present embodiment is formed by bringing circumferential end surfaces 76 of the pair of half bearings 41 and 42 in abutment with each other so that the pair of half bearings 41 and 42 are combined into a cylindrical shape as a whole (see FIG. 2). The half bearing 41 or 42 has a slide layer made of a Cu bearing alloy or an Al bearing alloy, or has a back metal layer made of an Fe alloy and the slide layer made of a Cu bearing alloy or an Al bearing alloy. In addition, the slide layer may have, on a slide surface 7 (and also on an inner surface of an axial groove 71 described below), a surface portion made of one selected from the group consisting of Bi, Sn and Pb softer than the bearing alloy, a surface portion made of an alloy mainly containing the above metals, or a surface portion made of a resin composition mainly containing synthetic resin. However, it is preferable that the inner surface of the axial groove 71 does not have these surface portions. This is because, when the oil contains a large amount of foreign matters, the foreign matters tend to be embedded or accumulated in the soft surface portion serving as the inner surface of the axial groove 71. If the foreign matters are embedded or accumulated in the inner surface of the axial groove 71, turbulent flow tends to be generated in the oil flowing in the axial groove 71.

FIG. 2 shows a view in which the upper half bearing 41 which bears the journal portion 6 shown in FIG. 1 is seen from an axial direction.

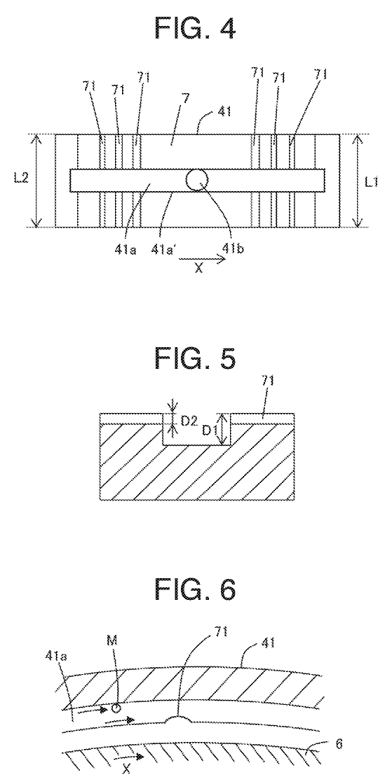

As shown in FIG. 3 and FIG. 4, the oil groove 41a is formed in the axial center of the inner peripheral surface of the upper half bearing 41 to extend in the circumferential direction. In Embodiment 1, a groove depth of the oil groove 41a, and an axial length of the oil groove 41a (the width of the oil groove 41a) are substantially constant (or of the same dimensions) over the circumferential direction of the upper half bearing 41. When the diameter of the journal portion 6 of the crankshaft of the small-size internal combustion engine is 40 to 100 mm, the groove depth of the oil groove 41a is approximately 0.7 mm to 2.5 mm. The larger the diameter of the journal portion 6 is, the larger the groove depth of the oil groove 41a is.

It should be noted that the axial length (width) of the oil groove 41a may be maximized in the vicinity of the circumferentially central portion of the oil groove 41a, and decrease toward both circumferential end surfaces of the oil groove 41a. Further, the groove depth of the oil groove 41a may be maximized in the vicinity of the circumferentially central portion of the oil groove 41a, and decrease toward both circumferential end surfaces of the oil groove 41a.

Furthermore, the oil hole 41b is formed in the oil groove 41a to pierce through the wall of the upper half bearing 41 in the radial direction. In the present embodiment, one oil hole 41b is formed in the axial center of a circumferentially central portion C of the upper half bearing 41. The diameter of the entrance opening 6c of the lubricating oil path 6a on the surface of the journal portion 6 is approximately 3 to 8 mm in general, and the axial length of the oil groove 41a is set to a dimension slightly larger than the diameter of the entrance opening 6c of the lubricating oil path 6a. In Embodiment 1, an opening of the oil hole 41b is circular, and the diameter of the opening has the same dimension as the axial length of the oil groove 41a. It should be noted that the dimension of the opening of the oil hole 41b, the shape of the opening, the formation position of the oil hole 41b, and the number of the formed oil holes 41b are not limited to the present embodiment.

On the inner peripheral surface of the upper half bearing 41, six axial grooves 71 extending are further formed on the slide surface 7 so as to intersect with the oil groove 41a. In the present embodiment, two groove groups 711 each composed of three axial grooves 71 are formed symmetrically with respect to the circumferentially central portion C of the upper half bearing 41, and each of the groove groups 711 is formed within a predetermined circumferential angle range θ1. The section of each of the axial grooves 71 perpendicular to the axial direction has an arc-shape as shown in FIG. 3, but may have a rectangular shape, an inverted trapezoidal shape, or the like.

FIG. 5 shows an axial section (a section in a plane including a central axis) (a section along the line A-A in FIG. 3) of the upper half bearing 41 at the position where the axial groove 71 is formed. In addition, the shape of the oil groove 41a in the axial section thereof is rectangular, but may be a sectional shape such as an arc or inverted trapezoidal shape. It should be noted that the groove depth of the oil groove 41a is constant (D1) within the axial section in the present embodiment. However, it would be understood that, if the sectional shape is an arc shape, an inverted trapezoidal shape, or the like, the groove depth D1 of the oil groove 41a corresponds to a maximum depth in the axial section.

The axial groove 71 has a groove depth D2 from the slide surface 7 in the radial direction at the place (i.e., a communication portion) of a longitudinal edge 41a′ of the oil groove 41a, and this groove depth D2 is less than or equal to 10% of the groove depth D1 of the oil groove 41a. Moreover, in the present embodiment, an axial length L2 of the axial groove 71 is equal to the axial length L1 of the upper half bearing 41, and is preferably equal to or more than 70% of the axial length L1. Further, the groove depth D2 of the axial groove 71 can be 0.5 to 30 μm, and is preferably 20 μm or less. Still further, a groove width W which is a circumferential length of the axial groove 71 is preferably 0.1 to 20 mm, and is yet preferably 10 mm or less.

The groove depth D2 and the groove width W of the axial groove 71 are constant over the axial direction of the upper half bearing 41 in the present embodiment, but may vary along the axial direction.

It should be noted that the lower half bearing 42 has the same configuration as the upper half bearing 41 except that the lower half bearing 42 does not include the oil groove 41a, the oil hole 41b, and the plurality of axial grooves 71.

### (Action and Effects)

FIG. 6 shows a state in which the crankshaft 6 has moved toward the upper half bearing 41 during high-speed rotation of a four-cycle internal combustion engine. As described above, the lubricating oil flowing in the oil groove 41a is accompanied by foreign matters M, and the foreign matters which are greater in specific gravity than the lubricating oil move along a groove bottom under an effect of a centrifugal force while moving in the lubricating oil groove 41a formed along the inner peripheral surface of the main bearing 4, due to the rotation of the crankshaft 6 relative to the main bearing 4. Thus, the number of the foreign matters in the lubricating oil flowing in an upper region of the lubricating oil groove 41a is few. The lubricating oil having a few number of foreign matters flowing in the upper region of the lubricating oil groove 41a smoothly flows into the axial groove 71 which is in fluid communication with the lubricating oil groove 41a, spreads over the inner peripheral surface of the upper half bearing 41, and thus brings about satisfactory lubrication.

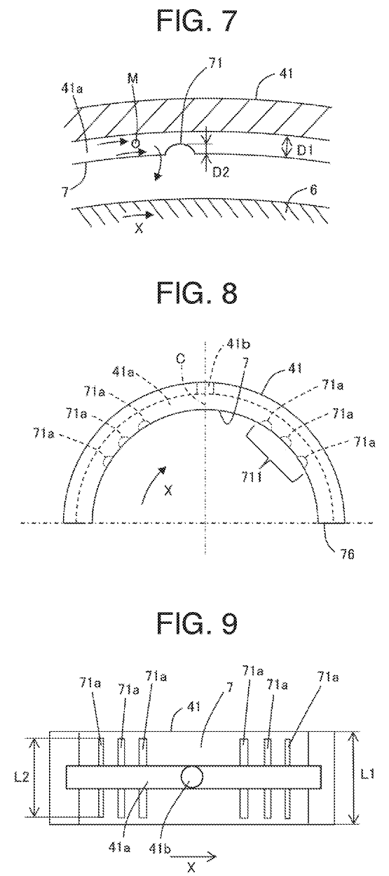

As shown in FIG. 7, when the crankshaft 6 moves away from the slide surface 7 of the upper half bearing 41, and a clearance between the surface of the crankshaft 6 and the slide surface 7 of the main bearing 4 increases, the lubricating oil flowing in the upper region of the lubricating oil groove 41a flows into the clearance between the crankshaft 6 and the slide surface 7 of the upper half bearing 41 along with the movement of the crankshaft 6 and, due to this flow of the lubricating oil, the lubricating oil containing the foreign matters M flowing in a lower region of the lubricating oil groove 41a moves to the upper region of the lubricating oil groove 41a. According to the present embodiment, since the groove depth D2 of the axial groove 71 is less than or equal to 10% of the groove depth D1 of the oil groove 41a, the foreign matters M which have moved to the upper region of the lubricating oil groove 41a do not easily enter the axial groove 71. However, if the groove depth D2 of the axial groove 71 is more than 10% of the groove depth D1 of the oil groove 41a, the foreign matters M which have been moving along the groove bottom surface of the lubricating oil groove 41a enter the axial groove 71, and are easily sent to the inner peripheral surface of the upper half bearing 41. Moreover, even if the groove depth D2 of the axial groove 71 is less than or equal to 10% of the groove depth D1 of the oil groove 41a, the foreign matters which have reached the opening of the axial groove 71 in the lubricating oil groove 41a easily enter the axial groove 71, and are therefore easily sent to the slide surface 7 of the upper half bearing 41, when a plurality of axial grooves 71 which are in fluid communication with the lubricating oil groove 41a extend not at 90° but extend while tilting in the same direction to the rotation direction of the crankshaft 6 in contrast to the slide bearing according to the present invention.

### Embodiment 2

As shown in FIG. 8 and FIG. 9, in contrast to the upper half bearing 41 according to Embodiment 1, an axial groove 71a according to Embodiment 2 is formed so as not to open at the axial end of the upper half bearing 41. That is, the axial length L2 of the axial groove 71a is smaller than the axial length L1 of the upper half bearing 41. The upper half bearing 41 according to Embodiment 2 has the same configuration as that according to Embodiment 1 in other respects.

### (Action and Effects)

The present embodiment has advantageous effects similar to those in Embodiment 1. Further, since the axial groove 71a is not open at both axial ends of the upper half bearing 41, the oil in the axial groove 71a less easily flows out of the bearing than in Embodiment 1.

### Embodiment 3

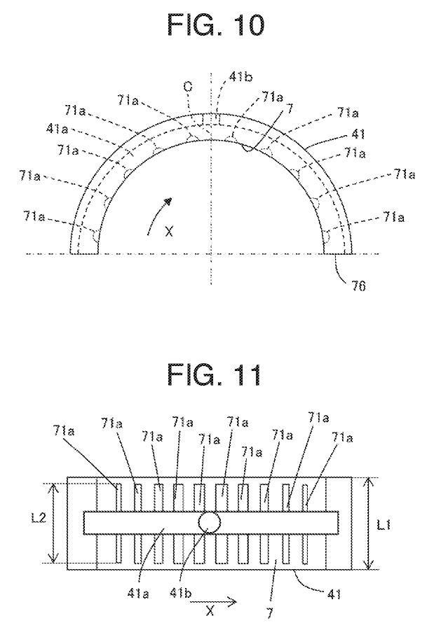

As shown in FIG. 10 and FIG. 11, in contrast to the upper half bearing according to Embodiment 1, the upper half bearing 41 according to Embodiment 3 has axial grooves 71a formed at even intervals in the circumferential direction over the entire inner peripheral surface of the upper half bearing 41. The axial length L2 of the axial groove 71a is smaller than the axial length L1 of the upper half bearing 41 as in Embodiment 2, and therefore, the axial groove 71a is configured so as not to open at both axial ends of the upper half bearing 41. The upper half bearing 41 according to Embodiment 3 has the same configuration as that according to Embodiment 1 in other respects.

When the present invention is applied to a main bearing for a crankshaft of an internal combustion engine of a general passenger vehicle, that is, a main bearing for a crankshaft in which a diameter of a journal portion 6 is approximately 40 mm to 100 mm, the plurality of axial grooves 71a provided at even intervals preferably have the same groove depth D2, the same axial length L2, and the same groove width W.

### (Action and Effects)

The present embodiment has advantageous effects similar to those in Embodiment 1, and since the slide surface 7 is provided between the plurality of axial grooves 71a, performance of bearing the journal portion 6 by the slide surface 7 becomes higher as compared with the case where the axial grooves 71a are formed on the entire inner peripheral surface. Moreover, in contrast to Embodiments 1 and 2, the axial grooves 71a are formed at even intervals on the entire circumference in the circumferential direction, the oil is more easily sent to the slide surface 7 than in Embodiments 1 and 2, and the oil is supplied to the entire inner peripheral surface.

It should be noted that, in Embodiments 1 to 3, a crush relief 70 may be provided adjacent to the slide surface 7 in each of the circumferential end regions of the upper half bearing 41 and the lower half bearing 42. In this case, the plurality of axial grooves 71a can be formed only on the slide surface 7.

The crush relief 70 corresponds to a surface formed by reducing the wall thickness of the half bearing from the original slide surface 7 in a radial direction in each of the circumferential end regions of the upper half bearing 41 and the lower half bearing 42. This surface is formed in order to absorb, for example, displacement and deformation of the circumferential end surface 76 of the half bearing that are caused when the pair of half bearings 41 and 42 are mounted in a bearing holding hole in the bottom part of the cylinder block 8. Therefore, the position of a curvature center of the surface of the crush relief 70 is different from the position of a curvature center of another region (the slide surface 7) (refer to SAE J506 (item 3.26 and item 6.4), DIN1497, section 3.2, and JIS D3102). In general, in the case of a bearing for a small-size internal combustion engine for a passenger vehicle, the depth of the crush relief 70 in the circumferential end surface 76 of the half bearing (a distance from the original slide surface 7 to the crush relief 70 in the circumferential end surface 76) is approximately 0.01 to 0.05 mm.

It should be noted that the bearing wall thickness (bearing wall thickness except the region where the crush relief 70 is formed, i.e., wall thickness in the region where the slide surface 7 is formed) of the upper half bearing 41 and the lower half bearing 42 is constant in a circumferential direction. However, the bearing wall thickness of the half bearing 41 or 42 are not limited thereto, and may be maximized in the circumferentially central portion C so as to continuously decrease toward both circumferential end surfaces 76.

1. A main bearing for rotatably supporting a journal portion of a crankshaft of an internal combustion engine, the journal portion comprising a cylindrical body portion, a lubricating oil path extending through the cylindrical body portion, and at least one entrance opening of the lubricating oil path formed on an outer peripheral surface of the cylindrical body portion, wherein
the main bearing comprises a pair of an upper half bearing and a lower half bearing which are combined with each other to form a cylindrical shape,
only the upper half bearing of the pair of half bearings comprises an oil groove formed on its inner peripheral surface to extend in a circumferential direction, and at least one oil hole extending through the upper half bearing from the oil groove to an outer peripheral surface of the upper half bearing, and the upper half bearing further comprises a plurality of axial grooves formed on its inner peripheral surface that extends in an axial direction so as to intersect with the oil groove, and
a groove depth (D2) of the axial groove is not more than 10% of a groove depth (D1) of the oil groove, and an axial length (L2) of the axial groove is not less than 70% of an axial length (L1) of the upper half bearing.

2. The main bearing according to claim 1, wherein the groove depth (D2) of the axial groove measured from the inner peripheral surface in a radial direction is 0.5 to 30 μm.

3. The main bearing according to claim 1, wherein a groove width (W) of the axial groove corresponds to a circumferential length of 0.1 to 20 mm.

4. The main bearing according to claim 1, wherein a group of grooves consisting of at least three of the axial grooves is formed within a predetermined circumferential area on the inner peripheral surface of the upper half bearing.

5. The main bearing according to claim 1, wherein the plurality of axial grooves are formed at even intervals over the entire circumference of the inner peripheral surface of the upper half bearing.

6. The main bearing according to claim 1, wherein the axial groove opens at both axial ends of the upper half bearing.

7. The main bearing according to claim 1, wherein the axial groove does not open at either axial end of the upper half bearing.
